(19) United States
(12) Patent Application Publication
(10) Pub. No.: US 2021/0373759 A1
(43) Pub. Date: Dec. 2, 2021

(54) TOUCH OPERATION METHOD AND TOUCH DEVICE USING THE SAME

(71) Applicant: ASUSTEK COMPUTER INC., Taipei (TW)

(72) Inventors: Jau-Yi WU, TAIPEI (TW); Sheng-Ta LIN, TAIPEI (TW)

(21) Appl. No.: 17/330,847

(22) Filed: May 26, 2021

(30) Foreign Application Priority Data
May 27, 2020 (CN) 202010460488.1

(51) Int. Cl. G06F 3/0488; G06F 3/041

(52) U.S. Cl. CPC G06F 3/04883; G06F 2203/04808; G06F 3/04164

(57) ABSTRACT

A touch operation method, applied to a touch device, and the touch device includes a touchpad. The touchpad includes a plurality of operation modes and is adapted for placing an external trigger member. The touch operation method includes: detecting a placement location or a coverage area of the external trigger member on the touchpad; defining an operable area on the touchpad according to the placement location or the coverage area; determining the target operation mode corresponding to the external trigger member among the operation modes; and executing the target operation mode in the operable area. A touch device is also provided to execute the touch operation method.

### CROSS-REFERENCE TO RELATED APPLICATION

This application claims the priority benefit of Chinese application serial No. 202010460488.1, filed on May 27, 2020. The entirety of the above-mentioned patent application is hereby incorporated by reference herein and made a part of specification.

### BACKGROUND OF THE INVENTION

### Field of the Invention

The disclosure relates to an operation method and, more particularly, to a touch operation method.

### Description of the Related Art

Traditional notebook computers are often equipped with keyboards and mice as input tools. However, for some more professional or more special usage scenarios, such as gaming or drawing, current notebook computers cannot provide high efficiency and convenient operation for a better user experience.

### BRIEF SUMMARY OF THE INVENTION

A touch operation method, applied to a touch device is disclosed. The touch device includes a touchpad. The touchpad includes a plurality of operation modes and adapted for placing an external trigger member. The touch operation method includes: detecting a placement location or a coverage area of the external trigger member on the touchpad; defining an operable area on the touchpad according to the placement location or the coverage area; determining a target operation mode among the operation modes corresponding to the external trigger member; and executing the target operation mode in the operable area.

A touch device coupled with an external trigger member is provided. The touch device comprises a touch pad and a control unit. The touchpad is adapted for placing the external trigger member. The control unit includes a plurality of operation modes, and is electrically connected to the touchpad. The control unit is used for: detecting a placement location or a coverage area of the external trigger member placed on the touchpad through the touchpad; defining an operable area on the touchpad according to the placement location or the coverage area; determining a target operation mode corresponding to the external trigger member through the external trigger member coupled with; and executing the target operation mode in the operable area.

A touch operation method, applied to a touch device, is also provided. The touch device includes a touchpad and a plurality of operation modes. The touchpad is adapted for placing a plurality of external trigger members. The touch operation method comprises: detecting a plurality of placement locations where the external trigger members are placed on the touchpad; defining an operable area covering the external trigger members on the touchpad when the distance between the placement locations of the external trigger members is less than a preset value; determining a target operation mode among the operation modes based on an arrangement of the external trigger members in the operable area; and executing the target operation mode in the operable area.

Through the touch operation method and the touch device provided, users can use the external trigger member to simply switch the desired operation mode without performing complicate setting adjustments. Therefore, the touch operation method and the touch device disclosed herein provide more efficient and convenient operation and better user experiences.

### BRIEF DESCRIPTION OF THE DRAWINGS

FIG. 1 is a block diagram of a touch device of an embodiment;

FIG. 2 is a flowchart of a touch operation method of an embodiment;

FIG. 3 is a flowchart of a touch operation method of another embodiment;

FIG. 4A to FIG. 4D show a touch operation method applied to a notebook computer; and

FIG. 5 is a schematic diagram of a touch device of another embodiment.

### DETAILED DESCRIPTION OF THE EMBODIMENTS

The embodiments of the present disclosure are disclosed in the following drawings, and for more clarity, the details of the disclosure will be described hereinafter. According to the following description and the claims, the advantages and features of this application will be clearer. It should be noted that the drawings are in a very simplified form and all use imprecise proportions, which are only used to conveniently and clearly assist in explaining the purpose of the embodiments.

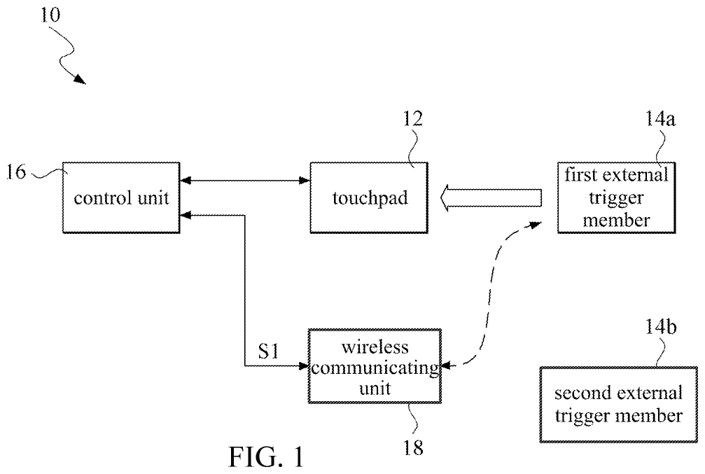

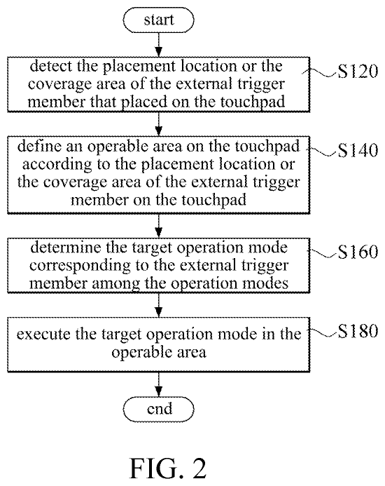

FIG. 1 is a block diagram of a touch device of an embodiment. FIG. 2 is a flowchart of a touch operation method of an embodiment. The touch operation method is suitable for the touch device shown in FIG. 1. In one embodiment, the touch device 10 is a notebook computer, but it is not limited thereto. In one embodiment, the touch device 10 is a tablet computer or other electronic device.

As shown in FIG. 1, the touch device 10 includes a touchpad 12, at least one external trigger member (two external trigger members 14a, 14b are taken as an example in this embodiment) and a control unit 16. The touchpad 12 configures to receive external touch signals, and includes multiple operation modes, such as a keyboard input mode, a handwriting input mode, and so on. The external trigger members used in this embodiment includes a first external trigger member 14a and a second external trigger member 14b, where the first external trigger member 14a is different from the second external trigger member 14b.

The two external trigger members 14a, 14b are placed on the touchpad 12 to trigger a specific operation mode. In other words, these external trigger members 14a, 14b correspond to a pre-defined operation mode. In this embodiment, the first external trigger member 14a corresponds to a first operation mode, the second external trigger member 14b corresponds to a second operation mode, and the combining arrangement of the first external trigger member 14a and the second external trigger member 14b corresponds to a third operation mode.

In one embodiment, the external trigger members 14a, 14b are accessories for physically operations, such as a button for pressing and operating, or a ruler for performing a physical measurement. The corresponding operation mode is set according to the physical operation of the external trigger member. For example, when the external trigger members 14a, 14b are buttons, the corresponding operation mode is the button input mode. In one embodiment, each of the two external trigger members 14a, 14b includes a specific shapes to indicate an operation mode, such as a pen-type member indicates a handwriting input mode.

The control unit 16 is electrically connected to the touchpad 12 for detecting placement locations or coverage areas of the external trigger members 14a, 14b that placed on the touchpad 12. The control unit 16 is wirelessly connected to the external trigger members 14a, 14b that placed on the touchpad 12 to determine the corresponding operation mode.

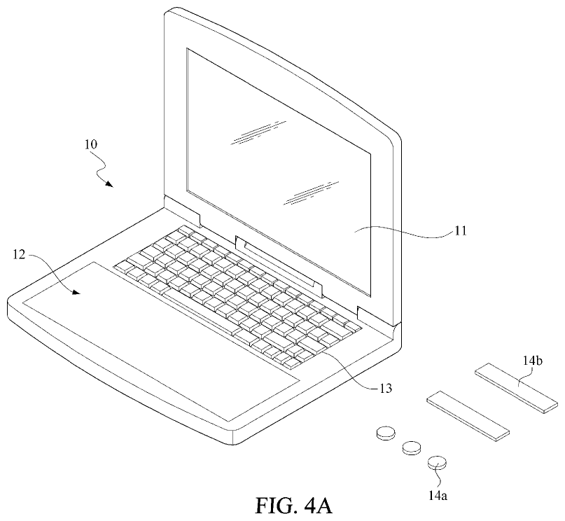

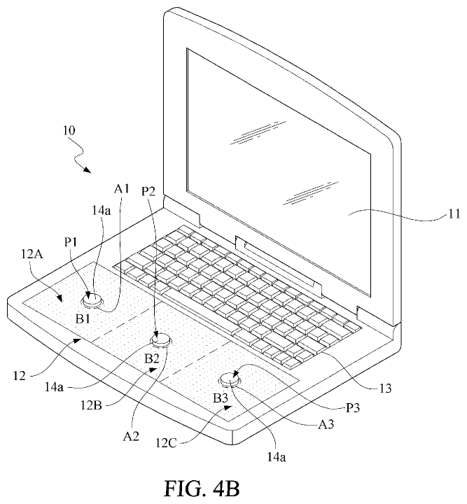

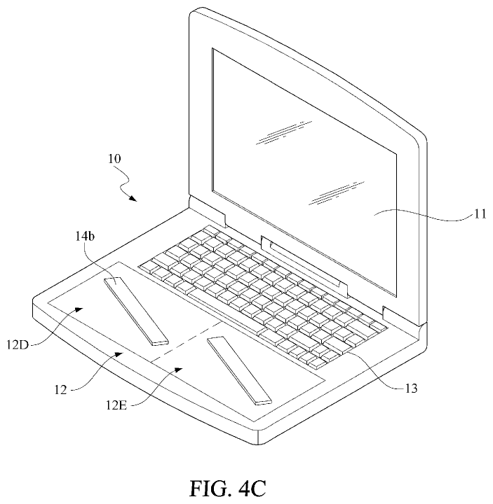

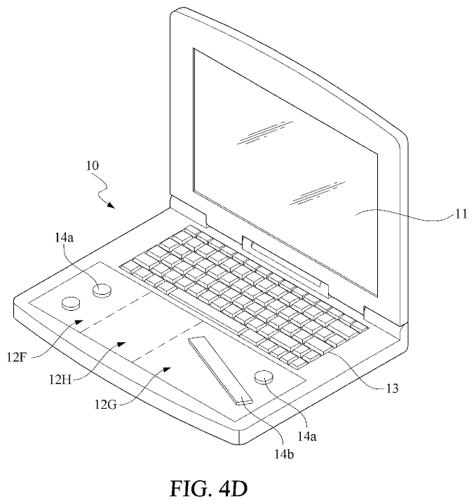

In one embodiment, the touch device 10 includes a wireless communicating unit 18 to be coupled to the control unit 16. The control unit 16 is electrically connected to the wireless communicating unit 18. The control unit 16 is connected to the external trigger members 14a, 14b via a communication protocol such as near field communication (NFC), Bluetooth (Bluetooth) to determine the corresponding operation mode, and the external trigger members 14a, 14b receives an operation mode signal S 1. The control unit 16 defines an operable area on the touchpad 12 according to the placement location or the coverage area of the external trigger members 14a, 14b on the touchpad 12, and executes the target operation mode within the operable area. For the setting of the operable area on the touchpad 12, see FIG. 4A to FIG. 4D for details.

Please refer to FIG. 2 and refer to FIG. 1 together. The touch operation method includes the following steps.

First, as shown in step S120, it is to detect the placement location or the coverage area of the external trigger member 14a that placed on the touchpad 12. In one embodiment, the step is performed by the control unit 16 in conjunction with the touchpad 12.

Subsequently, as shown in step S140, it is to define an operable area on the touchpad 12 according to the placement location or the coverage area of the first external trigger member 14a on the touchpad 12. In one embodiment, this step is performed by the control unit 16. The setting of the operable area on the touchpad 12 will be described in detail accompany with FIG. 4A to FIG. 4D.

Next, as shown in step S160, it is to determine the target operation mode corresponding to the first external trigger member 14a among the operation modes (that is, the operation modes of the touchpad 12). In one embodiment, it determines the target operation mode corresponding to the external trigger member 14a by coupling the external trigger member 14a in this step. In one embodiment, this step is performed by the control unit 16. In one embodiment, the control unit 16 wirelessly communicates with the external trigger member 14a to detect the operation mode corresponding to the external trigger member 14a.

Finally, as shown in step S180, it is to execute the target operation mode that determined in step S160 in the operable area. In one embodiment, this step is performed by the control unit 16 with the implementation of the touchpad 12.

In the foregoing embodiment, steps S140 and S160 are performed sequentially, but which is not limited herein. In an embodiment, the order of the two steps can be reversed, or be performed simultaneously.

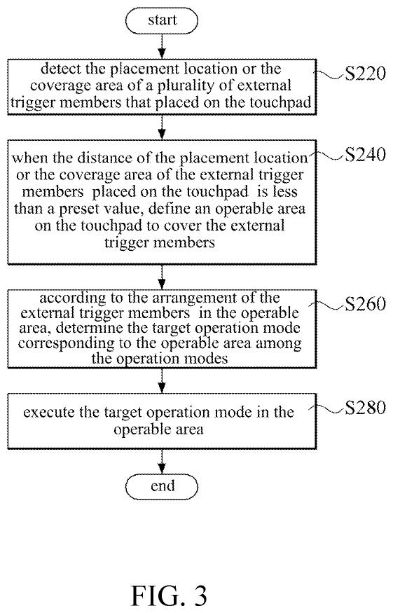

FIG. 3 is a flowchart of a touch operation method of another embodiment. The main difference between this embodiment and the embodiment of FIG. 2 is that multiple or a plurality types of the external trigger members 14a, 14b are used in this embodiment. The touch operation method is also applied to the touch device 10 that showed in FIG. 1. The touch device 10 defines a plurality of operation modes in advance based on the external trigger members 14a, 14b. In one embodiment, the touch device 10 defines different operation modes according to the types of the external trigger members 14a, 14b. In one embodiment, the touch device 10 defines different operation modes according to the types of the external trigger members 14a, 14b. In one embodiment, the touch device 10 defines different operation modes according to different arrangements of the external trigger members 14a and 14b. The placement of the external trigger members 14a, 14b on the touchpad 12 are showed in FIG. 4A to FIG. 4D.

First, step S220 performs to detect the placement location or the coverage area of a plurality external trigger members 14a, 14b that placed on the touchpad 12. In one embodiment, this step is performed by the control unit 16 with the implementation of the touchpad 12.

Subsequently, step S240 shows that when the distance between the placement location or the coverage area of the external trigger members 14a, 14b placed on the touchpad 12 is less than a preset value, define an operable area on the touchpad 12 to cover the external trigger members 14a, 14b. In one embodiment, this step is performed by the control unit 16. For the division and setting of the operable area on the touchpad 12, see FIG. 4A to FIG. 4D for details. When the distance of the placement location or the coverage area between the first external trigger member 14a and the second external trigger member 14b placed on the touchpad 12 is greater than the preset value, it is determined that each of the external trigger members 14a, 14b is independently been placed on the corresponding operable area, and execute the steps as aforementioned steps S140 to S180.

Following step S240, next, as shown in step S260, according to the arrangement of the external trigger members 14a, 14b in the operable area, it determines the target operation mode corresponding to the operable area among the operation modes (that is, the operation mode of the touchpad 12).

In one embodiment, step S240 determines the target operation mode corresponding to the operable area according to the external trigger members 14a, 14b coupling placed on the touchpad 12. In one embodiment, this step is performed by the control unit 16.

Finally, as shown in step S280, it executes the target operation mode in step S260 in the operable area. In one embodiment, this step is performed by the control unit 16 with implementation with the touchpad 12.

In the foregoing embodiment, steps S240 and S260 are performed sequentially, which is not limited herein. In an embodiment, the order of the two steps can be reversed, or be performed simultaneously.

FIG. 4A to FIG. 4D show implementation samples of the touch operation methods applied to a notebook computer. As shown, the touch device 10, e.g. the notebook computer, includes a display 11 and a host part. The host part includes a touchpad 12 and a keyboard module 13. The touchpad 12 is located on a side of the host part close to the user. FIG. 4A shows that the touch device 10 is in a default state, that is, the state of not using any of the external trigger members 14a, 14b. In one embodiment, this default state is a touch input state.

In one embodiment, as shown in FIG. 4B, when the user places the external trigger member 14a on the touchpad 12 (it shows three external trigger members 14a on the touchpad 12), please also refer to FIG. 1 to FIG. 3, the control unit 16 defines the operable area 12A, 12B, 12C around the placement location P1, P2, P3 based on the placement locations P1, P2, P3 (or the coverage area) of the external trigger members 14a placed on the touchpad 12, and execute the operation mode corresponding to the external trigger members 14a in the operable areas 12A, 12B, 12C.

Take buttons as an example. When the user places the buttons (the external trigger members 14a) on the touchpad 12, the control unit 16 executes the corresponding operation mode according to the buttons, such as the button input mode.

In the button input mode, the control unit 16 defines valid touch areas A1, A2, A3 (corresponding to the placement locations P1, P2, P3 or the coverage areas of the buttons) and invalid touch areas B1, B2, B3 in the operable area 12A, 12B, 12C, to facilitate the user to perform key operations, and prevent the user from accidentally touching the touchpad 12 and generating wrong touch signals at the same time.

In one embodiment, as shown in FIG. 4B, the user places the external trigger members 14a in different placement locations P1, P2, P3 of the touchpad 12 to divide the touch pad into a plurality of operable areas 12A, 12B, 12C. In this embodiment, the external trigger member 14a divides the touchpad 12 into a plurality of operable areas 12A, 12B, and 12C connected together, which is not limited herein.

In one embodiment, these operable areas 12A, 12B, and 12C are not connected. In one embodiment, an undefined area (not shown) is generated on the touchpad 12 to separate the operable areas 12A, 12B, and 12C. For the location of the undefined area, please refer to FIG. 4D and related descriptions.

In one embodiment, the operable area 12A, 12B, and 12C are square-shaped areas and extend to at least one edge of the touchpad 12. In one embodiment, please refer to FIG. 1 together, the control unit 16 sets an area defined by extending the placement location P1, P2, P3 (or the coverage areas) laterally outward for a preset distance as the operable areas 12A, 12B, 12C, according to the placement locations P1, P2, P3 (or the coverage areas) of the external trigger members 14a placed on the touchpad 12.

In the embodiment of FIG. 4B, the user uses the buttons as the external trigger members 14a to operate, which is not limited herein. As shown in FIG. 4C, according to actual needs, users use different external trigger members 14b (such as rulers as shown).

The second external trigger member 14b and the first external trigger member 14a each corresponds to different operation modes, for example, the button input mode, the handwriting input mode, or the mouse functions as left and right clicks. The touch device 10 receives the external trigger members 14b to determine the target operation mode and activate in the operable areas 12D, 12E of the touchpad 12 and activate the operation modes in the operable areas 12A, 12B, 12C which are different from the operable areas 12D, 12E shown in FIG. 4B.

In the embodiments of FIG. 4B and FIG. 4C, a single operable area is defined by a single external trigger member 14a or 14b, which is not limited herein. In one embodiment, as shown on the left side of the touchpad 12 in FIG. 4D, when the distance between the placement locations of the two external trigger members 14a is less than a preset value, the two external trigger members 14a jointly define the operable area 12F.

In one embodiment, the combining arrangements of different external trigger members 14a, 14b generate various different operation modes. In an embodiment, the operable area 12G is defined by two different types of the external trigger members 14a, 14b (a button and a ruler) at the right side of the touchpad 12 in FIG. 4D.

Furthermore, in one embodiment, the external trigger members include a first external trigger member (the external trigger member 14a, such as a button module) and a second external trigger member (the external trigger member 14b, such as a ruler), wherein the first external trigger member is different from the second the external trigger member. With the combination and arrangement of the two external trigger members 14a, 14b, the operation modes includes a first operation mode, a second operation mode, and a third operation mode, wherein, the first external trigger member 14a corresponds to the first operation mode, and the second external trigger member 14b corresponds to the second the operation mode, and the combining arrangement of the first external trigger member 14a and the second the external trigger member 14b) corresponds to the third operation mode.

In addition, in this embodiment, since the placement locations of the external trigger members 14a, 14b are at the left and right sides of the touchpad 12, the middle position of the touchpad 12 generates an undefined area 12H that separating the operable areas 12F, 12G. In one embodiment, the operation state of the undefined area 12H is similar to the invalid touch area B1, B2, B3, to prevent the user from accidentally touching and generating wrong touch signals.

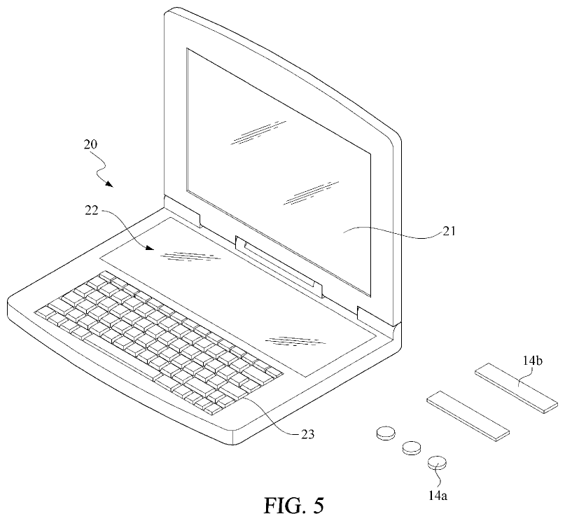

FIG. 5 is a schematic diagram of a touch device of another embodiment. Unlike the touch device 10 of FIG. 4A, the element that adapted to place the external trigger members 14a, 14 is a touchpad 12, the touch device 20 in this embodiment includes a touch panel 22 that adapts to place the external trigger member 14a, 14b.

The difference between the touch panel 22 and the touchpad 12 is that the touch panel 22 not only provides a touch input function as a touchpad, but also provides image displaying function. In one embodiment, taking a notebook computer as an example, the touch panel 22 is located between the display 21 and the keyboard module 23, and serves as a secondary display and an additional input device.

Through the touch operation method and the touch device provided, the external trigger members 14a, 14b are applied to switch the desired operation modes without performing complicated setting adjustments. Therefore, the touch operation method and the touch device provides users with more efficient and convenient operation and experience.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A touch operation method, applied to a touch device and used with an external trigger member, wherein the touch device includes a touchpad, and the touchpad includes a plurality of operation modes, the touch operation method comprising:
detecting a placement location or a coverage area of the external trigger member on the touchpad;
defining an operable area on the touchpad according to the placement location or the coverage area;
determining a target operation mode corresponding to the external trigger member among the operation modes; and
executing the target operation mode in the operable area.

2. The touch operation method according to claim 1, wherein the external trigger member is a physical button, and the operation modes include a button input mode.

3. The touch operation method according to claim 1, wherein the operable area extends to at least one edge of the touchpad.

4. The touch operation method according to claim 2, wherein the step of executing the target operation mode in the operable area comprises: defining a valid touch area and an invalid touch area in the operable area according to the placement location or the coverage area.

5. The touch operation method according to claim 1, wherein the step of executing the target operation mode in the operable area comprises: setting an invalid touch area outside the operable area according to the placement location or the coverage area.

6. The touch operation method according to claim 1, wherein, the operation modes include a handwriting input mode.

7. The touch operation method according to claim 1, wherein the step of determining the target operation mode corresponding to the external trigger member among the operation modes comprises: receiving an operation mode signal from the external trigger member, and determining the target operation mode corresponding to the external trigger member based on the operation mode signal.

8. A touch device, coupled with an external trigger member, the touch device comprising:
a touchpad, adapted for placing the external trigger member; and
a control unit, including a plurality of operation modes, and electrically connected to the touchpad, wherein the control unit is used for:
detecting a placement location or a coverage area of the external trigger member placed on the touchpad through the touchpad;
defining an operable area on the touchpad according to the placement location or the coverage area;
determining a target operation mode corresponding to the external trigger member through the external trigger member coupled with; and
executing the target operation mode in the operable area.

9. A touch operation method, applied to a touch device, wherein the touch device includes a touchpad having a plurality of operation modes, and the touchpad is adapted for placing a plurality of external trigger members, the touch operation method comprising:
detecting a plurality of placement locations where the external trigger members are placed on the touchpad;
defining an operable area covering the external trigger members on the touchpad when a distance between the placement locations of the external trigger members placed on the touchpad is less than a preset value;
determining a target operation mode corresponding to the operable area among the operation modes based on an arrangement of the external trigger members in the operable area; and
executing the target operation mode in the operable area.

10. The touch operation method according to claim 9, wherein, the external trigger members include a first external trigger member and a second external trigger member, the first external trigger member is different from the second external trigger member, the operation modes include a first operation mode, a second operation mode, and a third operation mode, the first external trigger member corresponds to the first operation mode, and the second external trigger member corresponds to the second operation mode, and the arrangement of the first external trigger member and the second external trigger member corresponds to the third operation mode.
